(19) United States
(12) Patent Application Publication
(10) Pub. No.: US 2024/0381912 A1
(43) Pub. Date: Nov. 21, 2024

(54) MODIFIED LIQUID OAT BASE

(71) Applicant: Arla Foods amba, Viby J (DK)

(72) Inventors: Michael Crafack, Ry (DK); Signe Munk Rydtoft, Viby J (DK); Lene Havgaard, Esbjerg V (DK); Line Friis Bakmann Christensen, Viby J (DK)

(21) Appl. No.: 18/690,995

(22) PCT Filed: Sep. 19, 2022
(86) PCT No.: PCT/EP2022/075908

§ 371 Date: Mar. 11, 2024

(30) Foreign Application Priority Data
Sep. 20, 2021 (EP) 21197705.3

(51) Int. Cl. A23L 7/104; A23C 11/10; A23F 5/46

(52) U.S. Cl. CPC A23L 7/107; A23C 11/10; A23F 5/465; C12Y 302/01001; C12Y 304/24

(57) ABSTRACT

The present invention relates to a process for enzy matically modifying an oat base using a specific order and combination of enzymes, including a first liquefying alpha-amylase, a second maltogenic saccharifying alpha-amylase and an endoprotease. In particular, the present invention relates to oat bases obtainable by such process and uses thereof in hot acidic beverages, such as in coffee.

### TECHNICAL FIELD OF THE INVENTION

The present invention relates to a process for enzymatically modifying an oat base. In particular, the present invention relates to oat bases obtainable by such process and uses thereof in beverages e.g. in hot acidic beverages, such as in coffee.

### BACKGROUND OF THE INVENTION

There is a request in the market for oat drinks or oat products, which are better suited for retaining its functional characteristics over a wider range of temperatures and pH while preserving organoleptic parameters acceptable to the consumer.

Compared to other cereal grains, oats contain higher protein levels with a better amino acid composition. In addition, oats only contain minute amounts of gluten and is therefore tolerated well by people suffering from celiac. Altogether this makes oats a preferred plant material. However, oat proteins have low solubility and poor functional properties and it is of great interest to improve these characteristics.

WO 2004/006691 A2 discloses an enzymatic process for generation of foods, feedstuffs and ingredients wherein a plant material is in a first step treated with a protease followed by a second step of treatment with an alpha-amylase.

US2020/268022 A1 discloses oat-based beverage composition comprising oat flour, alpha-amylase and glucoamylase.

US 2013/251850 A discloses the preparation of a hydrolysed whole grain composition. In example 1, Validase HT 425 L (alpha-amylase) optionally with Alcalase 2.4 L (protease) are used to hydrolyse wheat, barley and oats.

Hence, an improved process for producing modified oat bases would be advantageous, and in particular a more efficient and/or reliable modified oat base for use in beverages such as oat drinks e.g. to be mixed into hot beverages would be advantageous.

### SUMMARY OF THE INVENTION

As outlined above, there is a request in the market for oat drinks, which are better suited for being mixed into hot beverages, such as hot acidic beverages like coffee. There is also a strong demand for oat drinks, which are organic or “clean label” or at least free from GMO or enzymes produced in a GMO. However, commercially available enzymes which can modify oat components are generally genetically modified or produced in a genetically modified organism to have an increased activity and/or higher production yields. It is therefore not a straight-forward task to develop a process to modify oat to a degree allowing it to resistant to temperature increases and lower pH, e.g. for use in hot beverages while preserving organoleptic parameters acceptable to the consumer using only enzymes which are not produced in a GMO.

The present invention relates to an optimized process for producing an enzymatically modified oat base using at least two (non-modified and not produced in a GMO) alpha-amylases and one (non-modified and not produced in a GMO) endoprotease in a particular optimized order.

As outlined further below,
the first alpha-amylase is a liquefying endo alpha-amylase, which primarily degrades starch at random, producing dextrins of differing chain lengths and oligosaccharides, such as BAN; and
the second alpha-amylase is a maltogenic saccharifying alpha-amylase, which is a maltose liberating alpha-amylase (maltogenic), such as Fungamyl.
The endoprotease is preferably a metalloendoprotease, more preferably Neutrase.

Thus, two different types of alpha-amylases are used in the process according to the invention together with an endoprotease in an optimized order.

Thus, an object of the present invention relates to the provision of an optimized process for producing clean label/organic oat bases. These oat bases are suitable for use in hot (acidic) beverages such as coffee.

Example 1 shows that some “organic” (non-GMO derived) amylase enzymes have undesired side effects, such as proteolytic activity, which is considered responsible for undesired organoleptic parameters such as bitterness and astringency.

Example 2 shows that the process of the invention provides a unique and optimized peptide and sugar profile, compared to other processes, while preserving the ability to be used in products that can be labelled “organic”. Further, example 2 shows that a lower concentration of enzymes may be used using the process of the invention.

Example 3 further shows, without being bound by theory, this unique sugar/peptide profile makes the produced oat base better suited for being mixed into hot acidic beverages (such as coffee), by having less precipitation/flocculation.

Example 4 shows compositions comprising the modified liquid oat base according to the invention.

Example 5 shows the effect of saccharification by a fungal (maltogenic) saccharifying alpha-amylase at different incubation temperatures.

Example 6 shows that the process of the invention can be transferred to industrial scale and further that the modified oat base according to the invention has improved stability towards aggregation and precipitation when mixed into hot acidic coffee.

In particular, it is an object of the present invention to provide a liquid oat base that solves the above-mentioned problems of the prior art with being organic and/or clean label while being able to preserve organoleptic parameters when mixed into hot beverages.

Thus, one aspect of the invention relates to a process for providing a (modified) liquid oat base, the process comprising:
a) mixing an oat material with a first endo alpha-amylase and incubate at a temperature at which the first alpha-amylase has amylase activity, such as in the range 65-77° C., thereby providing a first modified oat composition;
b) adjusting the temperature of the first oat composition of step a), such as to 57-63° C.;
c) adding a second alpha-amylase and an endoprotease to the first modified oat composition of step b), and incubate at a temperature at which the second alpha-amylase and the endoprotease have amylase activity and endoprotease activity respectively, such as in the range 57-63° C., thereby providing a second modified oat composition; and
d) adjusting the temperature of the second composition of step c) to inactivate the enzymes and pasteurize said second modified oat composition, such as at a temperature of at least 85° C.; and thereby
e) providing a modified liquid oat base.

In a preferred aspect, the invention relates to a process for providing a modified liquid oat base, the process comprising:
a) mixing an oat material with a first liquefying endo alpha-amylase and incubate at a temperature in the range 65-80° C. at which the first liquefying alpha-amylase has amylase activity, thereby providing a first modified oat composition;
b) adjusting the temperature of the first oat composition of step a), such as to 57-63° C.;
c) adding a second maltogenic saccharifying alpha-amylase and an endoprotease to the first modified oat composition of step b), and incubate at a temperature in the range 50-65° C., at which the second maltogenic saccharifying alpha-amylase and the endoprotease have amylase activity and endoprotease activity, respectively, thereby providing a second modified oat composition; and
d) adjusting the temperature of the second composition of step c) to inactivate the enzymes and pasteurize, such as at a temperature of at least 85° C.; and
e) providing a modified liquid oat base.

Another aspect of the present invention relates to a modified oat base obtained/obtainable by a process according to the invention.

Still another aspect of the present invention is to provide a modified liquid oat base comprising
a first liquefying alpha-amylase, such as BAN, preferably inactivated;
a second saccharifying alpha-amylase, such as a maltose liberating alpha-amylase (maltogenic), such as Fungamyl, preferably inactivated; and
a metalloendoprotease, preferably Neutrase, preferably inactivated.

In a preferred embodiment the modified liquid oat base comprises
a first inactivated liquefying alpha-amylase, such as BAN;
a second inactivated maltogenic saccharifying alpha-amylase, such as Fungamyl; and
an inactivated metalloendoprotease, preferably Neutrase.

Further, the invention relates to food ingredients and food products comprising the modified liquid oat base according to the invention and uses thereof.

### BRIEF DESCRIPTION OF THE FIGURES

FIG. 1 shows sensory evaluation of oat materials after treatment with different amylase enzymes.

FIG. 2 shows peptide mapping results from LC-MS/MS analysis.

FIG. 3 shows SDS-PAGE analysis of the eight recipes described in Table 1(example 2). Analysis was done using reducing conditions. Lanes 1-8 represent recipes 1-8 as described in Table 1. Lane 9 and 10 are reference samples of bovine milk-derived cheese and skimmed milk, respectively. Lane 11 is a molecular weight protein marker and the corresponding molecular weights are indicated.

FIG. 4 shows peptide mapping results from LC-MS/MS analysis of the eight recipes described in Table 1 (example 2).

FIG. 5 shows sugar profiles of the eight different recipes in example 2. The peaks, from left to right represent glucose, sucrose, maltose and maltotriose, respectively.

FIG. 6 shows dextrin (degree of polymerization (DP): DP4-DP8) profiles of the eight different recipes in example 2. The peaks, from left to right, represent DP4, DP5, DP6, DP7, DP8 and >DP8.

FIG. 7 shows the effect of adding the modified oat base to coffee (pH 4.8) and evaluating on the stability of the oat base by visual inspection after 10 min. Left: Enzyme combination: BAN/Fungamyl. This drink ‘separates’ in coffee as seen by the appearance of visual aggregates and sedimentation after 10 min. Right: Enzyme combination: BAN/Fungamyl/Neutrase. Homogenous appearance, no visual separation.

FIG. 8 shows the sugar profiles of the samples incubated with the maltogenic saccharifying alpha-amylase Fungamyl 800 L at different temperatures (50° C., 55° C., 58° C., 60° C., and 63° C.).

The present invention will now be described in more detail in the following.

### DETAILED DESCRIPTION OF THE INVENTION

### Definitions

Prior to discussing the present invention in further details, the following terms and conventions will first be defined:

### Clean Label

In the present context, the term “Clean Label” is to be understood as making a product using as few ingredients as possible and making sure those ingredients are items that consumers recognise and regard as wholesome. It includes foods with easy-to-recognise ingredients and no artificial flavours or synthetic chemicals.

### Organic

In the present context, the term “organic” may refer to Regulation (EU) 2018/848 of the European Parliament and of the Council of 30 May 2018 on organic production and labelling of organic products and repealing Council Regulation (EC) No 834/2007.

Regulation 2018/848 for example states:
“The use of ionising radiation, animal cloning and artificially induced polyploid animals or genetically modified organisms (‘GMOs’), as well as products produced from or by GMOs, is incompatible with the concept of organic production and consumers' perception of organic products. Such use should therefore be prohibited in organic production”.
   Dextrinizing and/or Liquefying Alpha-Amylase

In the present context, the term “dextrinizing alpha-amylase” or “liquefying alpha-amylase” is to be understood as an alpha-amylase, which primarily degrades starch at random, producing dextrins of differing chain lengths and oligosaccharides. Thus, the terms “dextrinizing alpha-amylase” or “liquefying alpha-amylase” are used interchangeably herein and the one term is meant to incorporate the other.

Examples of liquefying alpha-amylases suitable for use in the present invention are BAN, Termamyl Classic, MATS L Classic, FoodPro ALT (DuPont), Validase BAA (DSM). Prefarably the liquefying alpha-amylase is BAN, more preferably BAN 480L.

### Saccharifying Alpha-Amylase

In the present context, the term “saccharifying alpha-amylase” is to be understood as a maltose liberating alpha-amylase (maltogenic), such as Fungamyl.

Examples of saccharifying alpha-amylases suitable for use in the present invention are Fungamyl and Mycolase (DSM), preferably Fungamyl 800L.

### Stability of Oat Compositions, Food Ingredients and Food Products

A reduced stability of the oat products, food ingredients or food products described herein can be observed as flocculation, particularly when added to hot acidic solutions such as coffee (see example 3). Flocculation can be observed as the formation of small flocs or flakes in the liquid suspension. Flocculation can be observed by visual inspection or measured physically, e.g. by photometric methods. The amount of flakes can also be measured as the volume or weight of the flakes after a sedimentation/centrifugation step. Flocculation is likely caused by protein aggregation and/or agglomeration of proteins, fibres and other components of the oat composition. A food product with reduced oat composition stability is expected to give rise to a smaller or larger degree of flocculation which is likely to reduce consumer satisfaction both due to the visual appearance of a food product and due to changes in the organoleptic perception of the food product. It is therefore desired that the oat products, food ingredients and food products described herein show a high degree of stability and preferably little to no flocculation.

In a preferred embodiment, the oat products, food ingredients or food products described herein are stable (does not separate/flocculate) for at least 10 minutes when mixed cold (5° C.) with a hot beverage such as coffee.

### Process for Producing a Modified Oat Base

As outlined above, there is a need for oat bases, which are clean label or organic, while also being able to meet consumer requirements in relation to organoleptic parameters when used over a certain temperature range and/or pH range, such as ready-to-drink beverages or when mixed into hot acidic beverages such as coffee. Thus, a first aspect of the invention relates to a process for providing a modified liquid oat base, the process comprising:
a) mixing an oat material with a first endo alpha-amylase (preferably BAN, more preferably BAN 480L) and incubate at a temperature at which the first alpha-amylase has amylase activity, such as in the range 65-77° C., thereby providing a first modified oat composition;
b) adjusting the temperature of the first oat composition of step a), such as to 57-63° C.;
c) adding a second alpha-amylase and an endoprotease to the first modified oat composition of step b), and incubate at a temperature at which the second alpha-amylase and the endoprotease have amylase activity and endoprotease activity respectively, such as in the range 57-63° C., thereby providing a second modified oat composition; and
d) adjusting the temperature of the second composition of step c) to inactivate the enzymes and pasteurize, such as at a temperature of at least 85° C.; and
e) providing a modified liquid oat base.

As outlined in the example section, modified oat bases produced according to the process of the invention shows favourable characteristics in relation to taste (example 1), peptide and sugar profile (example 2 and 5). These optimized characteristics provides stability in hot acidic beverages, such as coffee (example 3 and 6).

In a preferred embodiment of the invention, the process comprising:
a) mixing an oat material with a first liquefying endo alpha-amylase and incubate at a temperature in the range 65-80° C. at which the first liquefying alpha-amylase has amylase activity for a period of at least 10 minutes, thereby providing a first modified oat composition;
b) adjusting the temperature of the first oat composition of step a), such as to 57-63° C.;
c) adding a second maltogenic saccharifying alpha-amylase and an endoprotease to the first modified oat composition of step b), and incubate at a temperature in the range 50-65° C., at which the second maltogenic saccharifying alpha-amylase and the endoprotease have amylase activity and endoprotease activity, respectively, for a period of at least 10 minutes, thereby providing a second modified oat composition; and
d) adjusting the temperature of the second composition of step c) to inactivate the enzymes and pasteurize, such as at a temperature of at least 85° C.; and
e) providing a modified liquid oat base.

In another preferred embodiment:
the first endo alpha-amylase is BAN 480L;
the second alpha-amylase is Fungamyl; and
the endoprotease is a metalloendoprotease, preferably Neutrase.

In a preferred embodiment, the process further comprises the step of separating soluble from insoluble materials, such as by a decanter, before or after step d), preferably before step d), thereby removing insoluble materials.

Oat can be modified in different ways such as chemically or enzymatically. In yet an embodiment, the provided modified liquid oat base is an enzymatically modified oat base.

Industrially used enzymes are often produced in a GMO and/or the enzyme itself is genetically modified to optimize enzymatic activity. In a preferred embodiment of the invention, the first alpha-amylase, the second alpha-amylase and the endoprotease are not produced in a genetically modified organism, GMO (and can therefore be considered ‘classic’ or ‘wild-type’). This enables the final product (such as an oat drink) to be labelled ‘organic’. In the example section (examples 1 and 2) an optimized process has been identified using only ‘wild-type’ enzymes.

When using e.g. ‘wild-type’ enzymes it is difficult to obtain the same results as when using GMO-derived enzymes. Wild-type preparations are more prone to having side activities, lower activity and/or more narrow temperature optimums.

In one preferred embodiment, the provided process is for providing a modified liquid oat base having increased stability (reduced flocculation and aggregation of the oat base material, including proteins) in hot acidic beverages, such as coffee (compared to an unmodified liquid oat base and/or compared to an oat base only modified with BAN/Fungamyl (see example 3) and/or compared to an oat base modified as outlined in the examples of WO 2004/006691 A2). As shown in example 1, some wild-type alpha-amylase enzyme preparations have side activities such as undesired protease activity.

In an embodiment, the modified liquid oat base according to the present invention is stable for at least 10 minutes when mixed cold into a hot acidic beverage such as coffee (see example 3).

In one embodiment, a hot beverage is a beverage having a temperature above 80° C., preferably above, 85° C., or such as above 90° C., or having a temperature in the range 80-95° C., such as in the range 85-90° C.

In yet an embodiment, said hot beverage, such as coffee, has a pH below 7, such as below 6.8, such as below 6 or such as below 5.5.

### Step a)

Different enzymes may be used as the first (liquefying) endo alpha-amylase. Thus, in an embodiment, in step a) the first endo alpha-amylase is a liquefying alpha-amylase such as BAN (preferably BAN 480L), Termamyl Classic, MATS L Classic (DSM), FoodPro ALT (DuPont) and Validase BAA 1000L (DSM). In a preferred embodiment, the first liquefying alpha-amylase is BAN, preferably BAN 480L.

In an embodiment, the liquefying alpha amylase is preferably BAN (480L) and is provided at a concentration in the range 5-5000 ppm such as 50-5000 ppm, such as 100-2000 ppm, such as 200-1000 ppm, such as 300 to 700 ppm. Unless otherwise stated, ppm is defined as mg per kg of oat slurry comprising 15% (w/w) oat material.

The process of the invention may be performed on different types of oat materials ranging from whole kernels to flour. In an embodiment, in step a) the oat material is provided in a form selected from the group consisting of oat kernels, oat flakes and oat flour, preferably oat flakes. The oat material may additionally be processed before being further processed by the methods provided herein. For example, the oat material may be milled, flaked, grinded, heat-treated (e.g. steamed or radiated), defatted, sieved (e.g. endosperm flour). In a preferred embodiment, the oat material is steamed oat flakes. The pre-treatment is preferably designed to control the gelatinization, such that the oat material is gelatinized.

In a preferred embodiment, the oat material is treated to inactivate undesired enzymatic activities in the oat material, such as lipolytic activity, such as lipoxygenase and lipase activity. This can be obtained by heat or steam or radiation treatment.

Step a) may be performed at different temperatures. Thus, in an embodiment, step a) is
performed at a temperature in the range 60-95° C., such as 65-77° C., such as 67-75° C., such as 69-74° C., preferably such as around 72° C. (optimal for BAN 480L); and/or
performed for a period in the range 15-60 minutes, such as 15-40 minutes, such as 25-35 minutes.

In another embodiment, step a) is performed for a period of at least 10 minutes, such as at least 20 minutes, such as at least 30 minutes.

In yet another embodiment, step a) is performed for a period in the range 10-120minutes, such as in the range 15-90 minutes, preferably in the range 15-60minutes.

In one embodiment, in step a) the oat material is provided in a concentration of 10-30% (w/w), such as 10-25% (w/w), preferably 13-17% (w/w), most preferred 15% (w/w).

### Step b)

Step b) may be performed at different temperatures. Thus, in an embodiment, in step b) the temperature is adjusted to a temperature in the range 45-65° C., such as 55-63° C., such 56-60° C., preferably such as around 58° C.

### Step c)

Different enzymes may be used as the second (maltogenic saccharifying) alpha-amylase. Thus, in an embodiment, in step c) the second alpha-amylase is a saccharifying alpha-amalyse, such as a maltose liberating alpha-amylase (maltogenic), such as Fungamyl 800L and Mycolase (DSM).

In a preferred embodiment, the second maltogenic saccharifying alpha-amylase is preferably Fungamyl (more preferably Fungamyl 800L) and is provided at a concentration in the range 5-5000 ppm such as 50-5000 ppm, such as 100-2000ppm, such as 100-1000 ppm, such as 100 to 400 ppm. Unless otherwise stated, ppm is defined as mg per kg of oat slurry comprising 15% (w/w) oat material.

In yet an embodiment, in step c) the endoprotease is a metalloendoprotease, such as Neutrase and Delvoplant TNP (DSM).

In a preferred embodiment, the endoprotease is Neutrase and is provided at a concentration in the range 5-3000 ppm, such as 5-1000 ppm, such as 20-500ppm, such as 50-300 ppm or such as 50-200 ppm. Unless otherwise stated, ppm is defined as mg per kg of oat slurry comprising 15% (w/w) oat material.

During step c) a temperature must be used which allows for sufficient enzymatic activity of all enzymes used. Thus, in an embodiment, step c) is
performed at a temperature in the range 45-65° C., such as 55-63° C., such 56-60° C., preferably such as around 58° C.; preferably for a period in the range 10-120 minutes, such as 20-60 minutes, preferably such as 30-50 minutes.

In an embodiment, step c) is performed for a period of at least 10 minutes.

In another embodiment, step c) is performed for a period in the range 10-120 minutes, such as in the range 15-90 minutes, preferably in the range 15-60 minutes.

In another embodiment, in step c) the second alpha-amylase and the endoprotease are added sequentially or simultaneously, preferably sequentially, more preferably the second alpha-amylase is added before the endoprotease.

In a preferred embodiment,
the first endo alpha-amylase is a liquefying alpha amylase, such as BAN;
the second alpha-amylase is a saccharifying alpha-amylase, such as a maltose liberating alpha-amylase (maltogenic), such as Fungamyl; and
the endoprotease is a metalloendoprotease, preferably Neutrase. In example 2 (recipe 8) such a combination is used showing superior characteristics.

In another preferred embodiment,
the first endo alpha-amylase is BAN, preferably BAN 480L;
the second alpha-amylase is Fungamyl 800L; and
the endoprotease is Neutrase. In example 2 (recipe 8) such a combination is used, showing superior characteristics.

PH adjustment may be performed to ensure optimum enzymatic activity during hydrolysis (step b) and/or step c) and/or before an optional UHT to ensure optimum product stability.

PH can be adjusted to levels between pH 4 and pH 8 in any of the steps using conventional acidity regulators such as phosphoric-, lactic- or hydrochloric acids, sodium-, potassium- and calcium hydroxides. Furthermore, phosphates and carbonates can be used as acidity regulators, such as sodium-, potassium- and calcium phosphates, sodium-, potassium- and calcium carbonates. In a preferred embodiment, the acidity regulator is approved for organic use. In addition, fruit concentrates may be used to adjust pH.

In an embodiment, the pH is in the range 4-8 in step a) and/or step c), such as in step a) and step c), such as in steps a)-c), or such as in steps a)-d).

In another embodiment, the pH is in the range 5-7, such as 6-7, or such as 6.3-6.9 in step a) and/or step c), such as in step a) and step c), such as in steps a)-c), or such as in steps a)-d).

In a preferred embodiment, the pH is 6-7, such as 6.3-6.9 in at least step a) and/or step c), more preferably in step a) and step c).

### Step d)

In an embodiment, in step d) the temperature is adjusted to at least 90° C. for at least 60 seconds, such as 95° C. for 60-360 seconds such as 60-180 seconds, such as 60-120 seconds, preferably to at least 95° C. for at least 60 seconds.

In a preferred embodiment, the process further comprises the step of separating soluble from insoluble materials, such as by a decanter, before or after step d), preferably before step d), thereby removing insoluble materials.

### Step e)

The provided modified liquid oat base in step e) may have different characteristics. Thus, in an embodiment, the provided modified oat base in step e)
is suitable for use in hot acidic beverages, preferably when the modified oat base is mixed in cold in the hot acidic beverage; and/or
is for use in hot beverages; and/or
is stable in a hot acidic beverage such as coffee for at least 10 minutes (example 3); and/or
does not separate when mixed with a hot beverage such as coffee within at least 10 minutes (example 3); and/or
provides satisfactory organoleptic parameters to the consumer when mixed with a hot acidic beverage, such as coffee (see example 3); and/or
does not change the bitterness of the hot acidic beverage or at least shows a better bitterness profile (see example 1); and/or
is suitable for use in beverages such as tea or in cooking.
is suitable in ready-to-drink beverages, such as at a temperature in the range 2-10° C.

Stability/precipitation/separation in a mixture such as coffee, may be determined by visual inspection (see example 3).

The process of the invention does not require the use of additional enzymes to achieve the desired effect. Thus, in an embodiment, said process does not comprise the addition of exogenous beta-amylase, gamma-amylase, beta-glucanase, exogenous protein-deamidase, and/or exogenous glutaminase or transglutaminase.

The above list of enzymes may be unwanted during processing, since they may be categorized as GMO, generate undesired metabolites, generate unfavourable organoleptic characteristics, may be forbidden in food products in some regions and/or contain undesired side activities.

Further, to use a minimal number of enzymes to obtain a desired effect may also be more cost-effective and/or time efficient.

In yet an embodiment, said process is free from genetically modified enzymes and/or enzymes produced in a genetically modified organism (GMO).

In yet another embodiment, the process further comprises the step of an UHT treatment of the provided modified oat base.

In a further embodiment, the process further comprises the step of homogenization of the provided modified oat base.

### Oat Base Obtained/Obtainable by the Process of the Invention

The modified oat based obtained by the process of the invention will be different from known oat bases since a unique combination of enzymes is used. This will result in an oat base with unique peptide and starch profiles while also containing the (inactive) added enzymes. Thus, another aspect of the invention relates to a modified oat base obtained/obtainable by a process according to the invention.

### Modified Liquid Oat Base

As outlined above, the modified liquid oat base produced by the process of the invention, will have a unique composition of e.g. peptides, sugars and dextrins due to the combination of enzymes used to produce it. Thus, a further aspect of the invention relates to a modified liquid oat base comprising
a first liquefying alpha-amylase, such as BAN, preferably inactivated;
a second saccharifying alpha-amalyse, such as a maltose liberating alpha-amylase (maltogenic), such as Fungamyl, preferably inactivated; and
a metalloendoprotease, preferably Neutrase, preferably inactivated.

In an embodiment, all the above enzymes are produced from a non-GMO.

In another embodiment, said modified oat base is free from genetically modified enzymes and/or enzymes produced in a genetically modified organism (GMO).

In yet another embodiment,
the first alpha-amylase is BAN, preferably BAN 480L;
the second alpha-amylase is Fungamyl (such as 800L); and
the first endoprotease is Neutrase.

In a preferred embodiment, the modified liquid oat base comprises
a first inactivated liquefying alpha-amylase, such as BAN;
a second inactivated maltogenic saccharifying alpha-amylase, such as Fungamyl; and
an inactivated metalloendoprotease, preferably Neutrase.

In yet a preferred embodiment, the modified liquid oat base comprises
inactivated BAN;
inactivated Fungamyl; and
inactivated Neutrase.

In an embodiment, the modified liquid oat base is free from active and/or inactive enzymes expressed from a GMO.

In a further embodiment, the modified liquid oat base meets the criteria of Regulation (EU) 2018/848 and can therefore be considered organic.

In yet an embodiment, the modified liquid oat base is free from exogenous beta-amylase, exogenous protein-deamidase, and/or exogenous glutaminase or transglutaminase.

It is to be understood that the modified liquid oat base has been modified by the listed enzymes before any inactivation.

### Food Ingredient

The modified oat base according to the invention may be combined with other food ingredients or food product, such as coffee. Thus, an aspect of the invention relates to a food ingredient comprising or consisting of the modified oat base according to the invention.

In an embodiment, the food ingredient further comprises one or more of vegetable oil, sodium chloride, dicalcium phosphate, tricalcium phosphate, calcium carbonate, flavour, hemp paste, malt extract, vanilla, cocoa, sugar, gellan, pectin, minerals and vitamins.

In a further embodiment, the food ingredient meets the criteria of Regulation (EU) 2018/848 and can therefore be considered organic.

### Food Product

Yet another aspect of the invention relates to a food product comprising or consisting of the food ingredient according to the invention.

In an embodiment, said food product is selected from the group consisting of a beverage, such as an oat drink, such as a ready-to-drink oat drink, acidic beverages, such as coffee, a plant based drink, smoothies, yogurt, ice cream, spoonable products, spreadables, and acidified products, such as sour crème alternatives.

In another embodiment, the food product is an oat drink suitable to be mixed into coffee. Preferably a coffee drink suitable to be mixed cold into a hot acidic beverage, such as coffee, while preserving organoleptic parameters acceptable to the consumer. As outlined above, oat drinks have a tendency to separate/precipitate when mixed into hot coffee. This is not the case for the modified liquid oat base according to the invention.

In a further embodiment, the food product meets the criteria of Regulation (EU) 2018/848 and can therefore be considered organic.

### Uses

A further aspect of the invention relates to the use of the food ingredient according to the invention or the food product according to the invention in a hot (acidic) beverage, such as in coffee.

Yet a further aspect of the invention relates to the use of the food ingredient according to the invention or the food product according to the invention in a fermented oat based product.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1—Comparison of Side Protease Activity of Amylase Enzyme Preparation From Non-GMO Organisms

### Aim of Study

To optimize the process for producing a modified oat base by identifying suitable commercially available liquefying alpha-amylase.

### Materials and Methods

10% oat flour suspensions were prepared using very fine milled oat flour (Sweoat P12, Swedish Oat Fibre AB, Sweden) and tap water. Solutions were heated to 70° C. and added with 0.05% (w/w) of a commercial liquefying alpha-amylase.

Two alpha-amylases were compared: FoodPro ALT (Bacillus subtilis) (DuPont, USA) and BAN 480L (Bacillus amyloliquefaciens) (Novozymes A/S, Denmark). Both enzymes are produced from classical (non-GM) organisms and are therefore suitable for organic production. After 1 hour incubation, samples were analyzed with LC-MS/MS, a technique known to the person skilled in the art.

For sensory evaluation, new 10% oat flour suspensions were prepared from Sweoat P12 oat flour to a total volume of 500 mL. These samples were heated to 65° C., added with 0.02% (w/w) enzyme and incubated 1 h with rotation before inactivation at 90° C. for 10 min and subsequent cooling to 5° C.

### Results

### Sensory Evaluation:

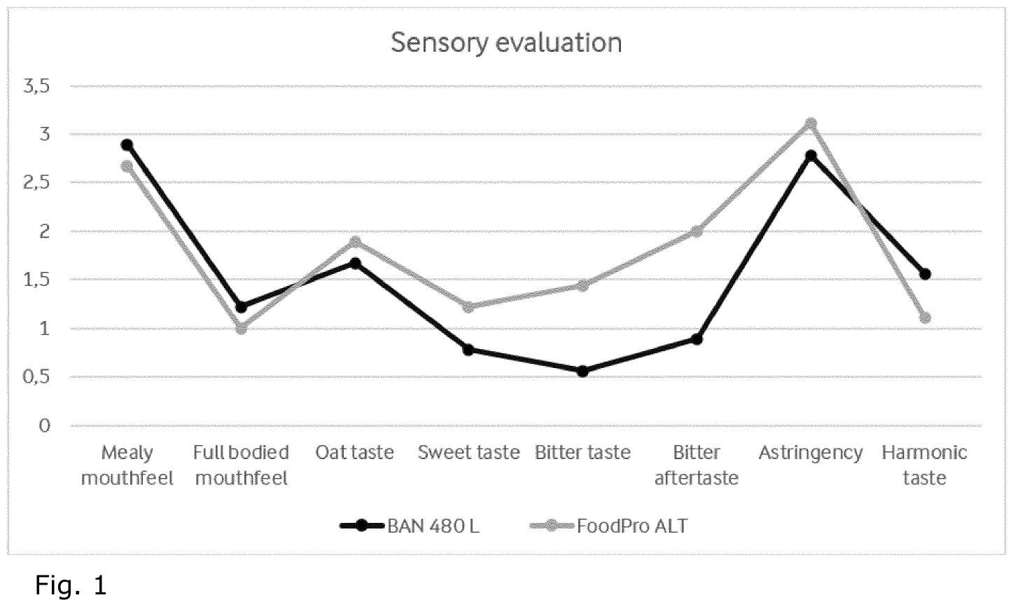

Sensory evaluation by consensus mapping (6-8 persons) was performed to compare different oat base preparations made with the two different commercial alpha-amylases. Selected attributes were scored on a 0-5 scale. The results clearly show an increased level of bitterness and astringency for the drink made with FoodPro ALT compared to the drink made with BAN 480L (FIG. 1). This bitterness was not masked by the increased sweet taste of this sample compared to the other.

### Peptide Mapping:

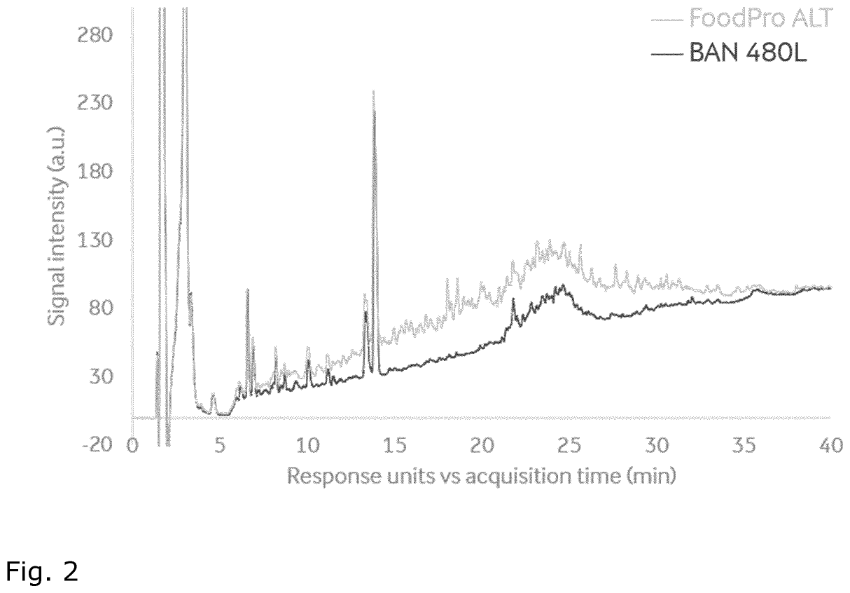

Peptide mapping analysis done with LC-MS/MS shows significantly higher levels of peptides in the sample with FoodPro ALT (grey curve) compared to the sample with BAN 480L (black curve) (FIG. 2), explaining the increase in bitterness and astringency found in the sensory evaluation for the FoodPro ALT sample (see FIG. 1). This strongly indicate proteolytic side activity of the FoodPro ALT enzyme preparation.

### Conclusion

Organic production of foodstuff and beverages put a number of restraints on which enzymes that can be used as they cannot be produced from genetically modified organisms, GMOs. This often results in less pure enzyme preparations with (unwanted) side activities. Through sensory evaluation and peptide analysis it was possible to identify an appropriate non-GMO derived commercial liquefying alpha-amylase that did not contain any significant proteolytic side activity.

Without being bound by theory, it is this proteolytic side activity, which is considered responsible for the undesired bitter taste astringency observed in the sensory tests.

### Example 2—Comparison of Order of Enzymes

### Aim of Study

To optimize the process for producing a modified oat base by identifying the most favorable order of enzyme addition.

### Materials and Methods

Several recipes were investigated in order to be able to optimize the process described in this invention to related technologies (i.e. the process described in example 3 of WO 2004/006691 A2, “Oat Bran Processing for Oat Bran Protein-Starch Beverage Production”) (recipe 2).
Recipe 1: Process without Neutrase (to know the effect of not adding protease).
Recipe 2: Process described in WO 2004/006691 A2.
Recipe 3: Process described in WO 2004/006691 A2 in reverse (with the alpha-amylase before the protease).
Recipes 4+5: protease is added before a liquefying alpha-amylase, using either the Neutrase conditions described in WO 2004/006691 A2 (45° C., 30 min—recipe 4) or from this invention: 58° C., 40 min (recipe 5). These are included to investigate if there is an advantage of adding protease before amylase.
Recipes 6+7: Liquefying alpha-amylase followed by protease using either Neutrase conditions from this invention; 58° C., 40 min (recipe 6) or the Neutrase conditions described in WO 2004/006691 A2; 45° C., 30 min (recipe 7). These are included to investigate if there is a clear advantage of incubating Neutrase at 45° C. compared to 58° C.
Recipe 8: Process according to the present invention (see also Table 1).

TABLE 1
Recipes, parameters and order of mixing

| | First enzyme | | | | Second enzyme | | | |
|---|---|---|---|---|---|---|---|---|
| | | Dose | Temp. | Time | | Dose | Temp. | Time |
| Recipe | Enzyme | (ppm) | (° C.) | (min) | Enzyme | (ppm) | (° C.) | (min) |
| 1 | BAN | 540 | 72 | 30 | Fungamyl | 225 | 58 | 40 |
| | (liq. alpha- | | | | (sacch. alpha- | | | |
| | amyl.) | | | | amyl.) | | | |
| 2 | Neutrase | 3200 | 45 | 30 | Termamyl | 3200 | 95 | 45 |
| | (protease) | | | | (liq. alpha- | | | |
| | | | | | amyl.) | | | |
| 3 | Termamyl | 3200 | 95 | 45 | Neutrase | 3200 | 45 | 30 |
| | (liq. alpha- | | | | (protease) | | | |
| | amyl.) | | | | | | | |
| 4 | Neutrase | 100 | 45 | 40 | BAN | 540 | 72 | 30 |
| | (protease) | | | | (liq. alpha- | | | |
| | | | | | amyl.) | | | |
| 5 | Neutrase | 100 | 58 | 40 | BAN | 540 | 72 | 30 |
| | (protease) | | | | (liq. alpha- | | | |
| | | | | | amyl.) | | | |
| 6 | BAN | 540 | 72 | 30 | Neutrase | 100 | 58 | 40 |
| | (liq. alpha- | | | | (protease) | | | |
| | amyl.) | | | | | | | |
| 7 | BAN | 540 | 72 | 30 | Neutrase | 100 | 45 | 30 |
| | (liq. alpha- | | | | (protease) | | | |
| | amyl.) | | | | | | | |
| 8 | BAN | 540 | 72 | 30 | Fungamyl | 225 + 100 | 58 | 40 |
| | (liq. alpha- | | | | (sacch. alpha- | | | |
| | amyl.) | | | | amyl.) + | | | |
| | | | | | Neutrase | | | |
| | | | | | (protease) | | | |

liq. alpha-amyl.: Liquefying alpha-amylase. Sacch. alpha-amyl.: Saccharifying alpha-amylase.

Below is exemplified how to read table 1 for recipe 8 and recipe 2.

For recipe 8:

### Step 1)

First alpha-amylase (liquefying)=540 ppm BAN 480L (72° C., 30 min)

### Step 2)

Second alpha-amylase (saccharifying)=200 ppm Fungamyl 800L (58° C., 40 min)+protease=100 ppm Neutrase 0.8L (added immediately after Fungamyl—not mixed together and added (58° C., 40 min).

All enzymes from Novozymes, all suitable for “organic” production.

For recipe 2:

### Step 1)

Protease=3200 ppm Neutrase 0.8L (45° C., 30 min)

### Step 2)

Alpha-amylase (liquefying)=3200 ppm Termamyl Classic (95° C., 30 min). Both enzymes from Novozymes, both are suitable for organic production.

Further details:

15% oat flour suspensions were prepared using whole grain oat flour (Valsemøllen A/S, Denmark) and tap water to a total volume of 50 mL. Solutions were treated with a first enzyme followed by treatment with a second enzyme according to Table 1. Enzymes BAN 480L, Termamyl Classic, Fungamyl 800L and Neutrase 0.8L were acquired from Novozymes A/S, Denmark. All incubations were done in tabletop waterbaths with occasional manual stirring or on a heating plate with magnetic stirring (the latter only for the 95° C. incubations). After enzymatic treatment, samples were heat treated to inactivate enzymes (100° C., 10 min) and frozen before further analysis.

Samples were analyzed for their protein and peptide content using complimentary analyses LC-MS/MS and SDS-PAGE, techniques known to the person skilled in the art. Samples were also analyzed for their carbohydrate profile using IC.

### Results

### SDS-PAGE:

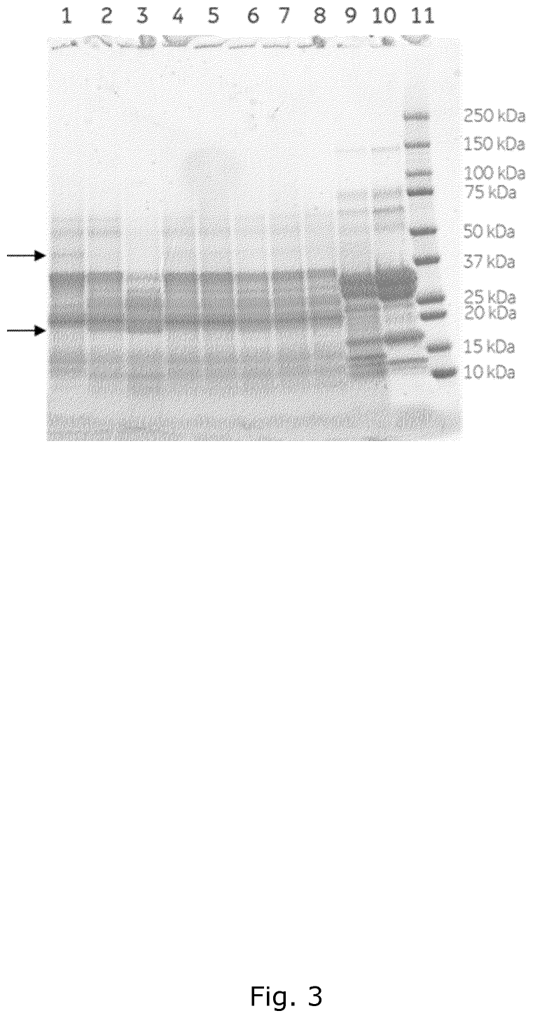

SDS-PAGE results (FIG. 3) show that only recipe 1 and 3 stands out while the rest of the recipes give similar results.

For recipe 1 (no protease included), a band around 45 kDa is seen more clearly than in the rest of the samples (see top arrow). In addition, the band just below the 22 kDa band—which is probably representing a degradation product—is missing (see bottom arrow).

For recipe 3, significantly more degradation of the larger oat proteins (>40 kDa) and the 35 kDa band can be observed. This clearly indicates that adding the alpha-amylase before the protease liberate oat proteins that are otherwise not accessible for the protease.

Visual inspection and comparison of lane 2 with lanes 4-8 show that increasing the Neutrase (protease) concentration more than 30-fold (as described in example 3of WO 2004 006691 A2) does not result in an overall increase in oat protein (MW>10 kDa) relative abundances.

### Peptide Mapping:

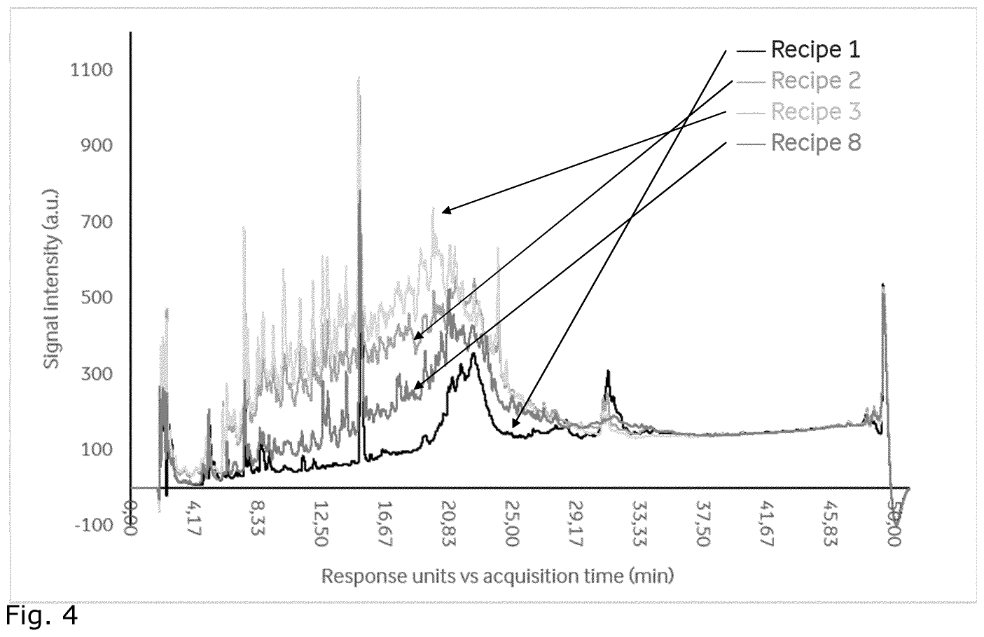

Peptide mapping analysis (FIG. 4) done with LC-MS/MS show the highest peptide levels for recipe 2 and recipe 3 where the Neutrase (protease) concentration is highest (3200 ppm compared to 100 ppm in recipes 4-8). The lowest levels are seen for recipe 1 where no protease has been included. While higher peptide levels could positively affect protein solubility, it could at the same time increase the risk of forming bitter peptides. Recipe 8 (using the process of the present invention) where the protease is added in the second enzymatic step, shows overall peptide levels between recipe 2/3 and 1. Bitter peptide formation is a well-described phenomenon when working with plant substrates, including oat proteins (see also Example 1).

### Sugar Profile:

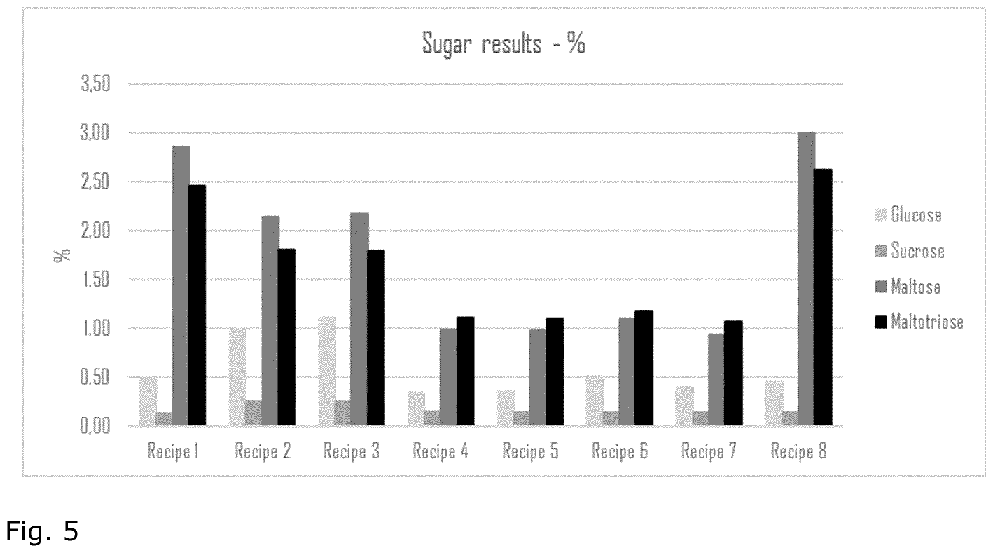

From the sugar profile (FIG. 5), it can be seen that including the saccharifying alpha-amylase Fungamyl increases the levels of both maltose and maltotriose (compare recipe 1 and recipe 8 with the rest of the samples) as expected. From these data, an effect of applying a much higher liquifying alpha-amylase concentration (>30-fold) on the glucose and sucrose levels (compare recipe 2and 3 to the rest of the samples) is seen, however, not to an extend that matches the fold increase in concentration.

### Dextrin Profile:

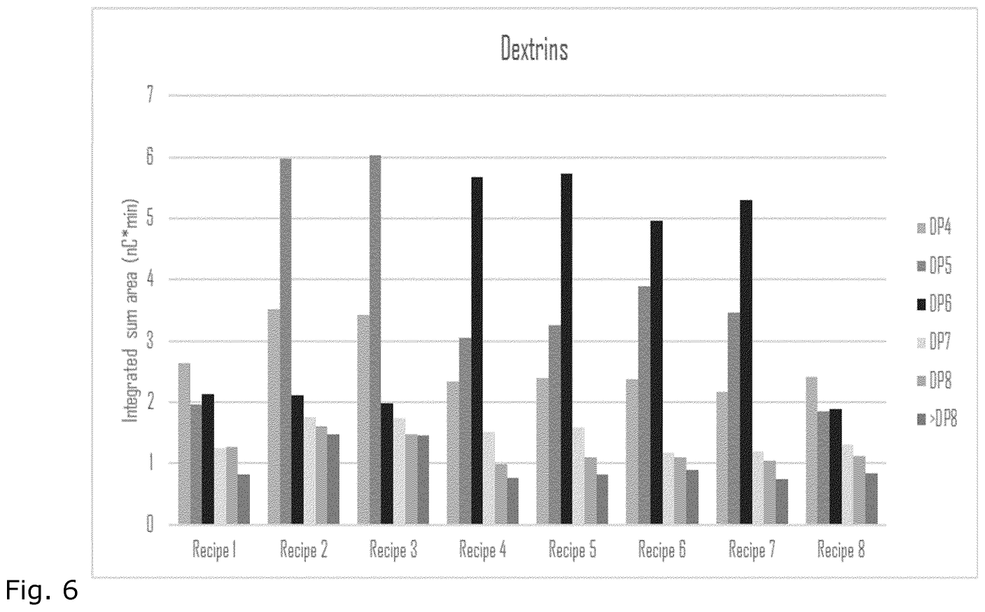

We see from the dextrin profile (FIG. 6) that the >30-fold higher concentration of a liquefying alpha-amylase results in 50-300% higher levels of DP5 and ˜50% higher levels of DP4 (compare recipe 2 and 3 with the rest of the samples). The presence of Fungamyl in recipes 1 and 8 give a large decrease in DP6 levels and a slight decrease in DP5 levels compared to the similar recipes 4-7 where Fungamyl was omitted. This corresponds nicely to the increase in maltose and maltotriose observed for recipe 1 and 8 compared to recipe 4-7 in FIG. 6.

### Conclusion

### Peptide Mapping:

The process described in this invention allows us to obtain similar levels of soluble oat proteins using only a fraction (reduced more than 30-fold) of the protease concentration as compared to related art. Also, by carefully selecting an appropriate non-GMO alpha-amylase enzyme that does not require highly elevated temperatures, we reduce the energy required to run the process and we reduce the risk of forming bitter peptides that could negatively affect the resulting modified oat base and its use in other products.

### Sugar Profile and Dextrin Profile:

The data presented in this example also clearly show that a carefully selected liquefying non-GMO alpha-amylase can be used at a low concentration and still liberate enough glucose to, when combined with a saccharifying alpha-amylase, give significantly higher levels of maltose and maltotriose, which can benefit the sensory properties of the oat base.

### Example 3—Stability in Coffee

### Aim of Study

To assess the tendency of oat drinks to precipitate when mixed into hot, acidic coffee.

Materials and Methods

Two oat drinks are formulated on oat bases produced using the enzyme combinations and hydrolysis conditions described in recipe 1 and 8 in example 1.

No stabilizers or buffering salt(s) are used in the formulations.

The stability of the oat drinks is assessed using the following procedure: oat drink is heated to 60° C. and frothed mechanically using a commercial milk-frother (Severin SM9685). 3 parts of frothed oat drink is mixed with 2 parts of coffee at 70° C. adjusted to pH 4.8 using citric acid. Oat drink and coffee is mixed and the stability assessed visually after 10 minutes.

### Results

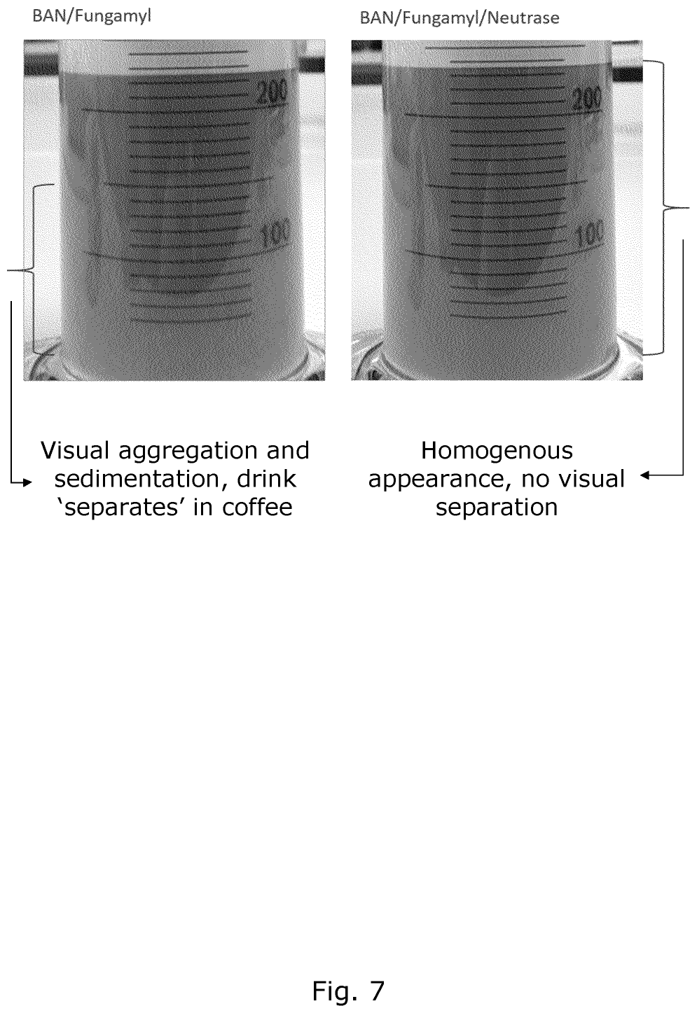

Visual inspection (tried visualized in FIG. 7), showed that the oat drink without a protease (Neutrase) (picture to the left) displayed aggregates, which can be observed in the lower two-thirds of the glass. The application of Neutrase in combination with a saccharifying alpha-amylase (Fungamyl 800L) (picture to the right) visually showed a reduced tendency of the drink to form aggregates.

### Conclusion

The combination of enzymes, sequence of application and specific hydrolysis conditions have great impact on the functional properties of oat bases and the products formulated hereof. In this example, the combination of a protease (Neutrase) and a saccharifying alpha-amylase (Fungamyl 800L) in the second enzymatic step surprisingly resulted in a modified oat base and oat drink, with improved stability towards aggregation and precipitation, when mixed into hot, acidic coffee.

### Example 4—Compositions Comprising the Modified Liquid Oat Base

### Aim of Study

To provide different compositions comprising the liquid oat base according to the invention.

Composition 1-Oat drink

| | Concentration |
|---|---|
| Ingredient | (% wt/wt) |
| Modified oat base | 70-95 |
| Rapeseed oil | 0.5-2 |
| Salt | 0.1-0.5 |
| Water | Up to 100 |

Composition 2-Oat drink

| | Concentration |
|---|---|
| Ingredient | (% wt/wt) |
| Modified oat base | 70-95 |
| Hemp paste | 0.5-2 |
| Salt | 0.1-0.5 |
| Water | Up to 100 |

Composition 3-Oat barista

| | Concentration |
|---|---|
| Ingredient | (% wt/wt) |
| Modified oat base | 70-95 |
| Rapeseed oil | 1-4 |
| Salt | 0.1-0.5 |
| Water | Up to 100 |

### Example 5—Effect of Saccharification at Different Temperatures

### Aim of Study

To evaluate the effect of saccharification by a fungal (maltogenic) saccharifying alpha-amylase at different incubation temperatures.

### Materials and Methods

15% oat flour suspensions were prepared using whole grain oat flour (Valsemøllen A/S, Denmark) and tap water to a total volume of 500 mL. The solution was heated to 72° C. and subsequently added 540 ppm of the liquefying endo alpha-amylase BAN 480 L (Bacillus amyloliquefaciens) (Novozymes A/S, Denmark) and incubated for 30 minutes in a tabletop waterbath with occasional manual stirring. After incubation the solution was aliquoted into 50 mL reaction tubes samples and heat treated (100° C., 10 min) for inactivation of BAN 480 L. Subsequenlty, the samples were transferred to tabletop waterbaths at various temperatures; 50° C., 55° C., 58° C., 60° C., and 63° C. When the desired incubation temperature was achieved the samples were each added 200 ppm of the maltogenic saccharifying alpha-amylase Fungamyl 800 L (Aspergillus oryzae) (Novozymes A/S, Denmark) and incubated for 40 min. After enzymatic treatment, samples were additionally heat treated (100° C., 10 min) to inactivate the Fungamyl 800 L addition and frozen before further analysis. Samples were analyzed for their carbohydrate profile using IC.

### Results

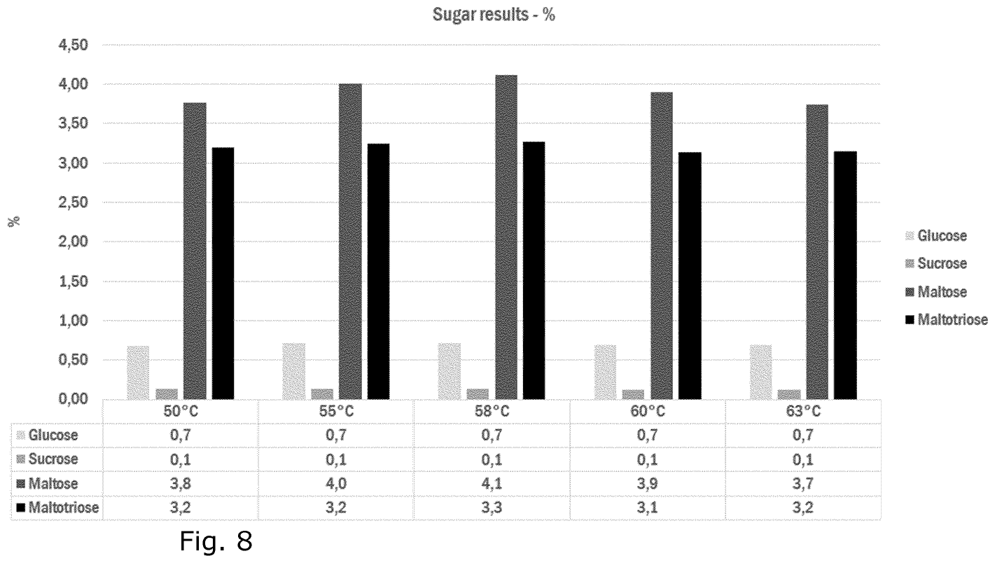

The sugar profiles of the samples incubated with Fungamyl 800 L at different temperatures (50° C., 55° C., 58° C., 60° C., and 63° C.) are seen in FIG. 8. The sugar profiles of the samples are similar with regard to glucose, sucrose and only subtle differences for maltotriose. The maltose content is highest in the sample incubated at 58° C. whereas samples kept at both higher and lower incubation temperatures achieves a lower content.

Conclusion The data presented in this example show that a fungal maltogenic saccharifying alpha-amylase can be applied over a certain temperature range and under the applied conditions achieve a similar sugar profile. However, to achieve the highest turnover of dextrins into maltose the optimum temperature in this setup was found to be 58° C.

### Example 6—Stability of Industrial Scale Produced Oat Drinks in Coffee

### Aim of Study

To identify the effect of the addition of a protease to oat drinks produced on industrial scale when tested for stability in coffee.

### Materials and Methods

Production of oat drink products was conducted on industrial scale. Two oat drinks were formulated on oat bases produced using the enzyme combinations and hydrolysis conditions described in recipe 1 and 8 in example 1. No stabilizers or buffering salt(s) was used in the formulations. The stability of the oat drinks was assessed using the procedure described in example 4.

### Results

Visual inspection of the oat drink mixed into hot acidic coffee was evaluated and scored on a scale from 1-10 with 1 indicating no level of aggregation and 10indicating a high level of aggregation. Visual inspection showed that the oat drink without a protease (Neutrase) displayed aggregates and was scored as 6. The application of Neutrase in combination with a saccharifying alpha-amylase (Fungamyl 800L) in the second enzymatic step visually showed a reduced tendency of the drink to form aggregates. This visual inspection was scored as 3.

### Conclusion

The identified combination of enzymes, sequence of application and specific hydrolysis conditions in laboratory scale was successfully transferred to industrial scale. The resulting oat drinks performed similar to previous laboratory produced oat drinks when testing their stability in coffee. The combination of a protease (Neutrase) and a saccharifying alpha-amylase (Fungamyl 800L) in the second enzymatic step resulted in a modified oat base and oat drink, with improved stability towards aggregation and precipitation when mixed into hot acidic coffee.

1. A process for providing a modified liquid oat base, the process comprising:
a) mixing an oat material with a first liquefying endo alpha-amylase and incubate at a temperature in the range 65-80° C. at which the first liquefying alpha-amylase has amylase activity, thereby providing a first modified oat composition;
b) adjusting the temperature of the first oat composition of step a);
c) adding a second maltogenic saccharifying alpha-amylase and an endoprotease to the first modified oat composition of step b), and incubate at a temperature in the range 50-65° C., at which the second maltogenic saccharifying alpha-amylase and the endoprotease have amylase activity and endoprotease activity, respectively, thereby providing a second modified oat composition; and
d) adjusting the temperature of the second composition of step c) to inactivate the enzymes and pasteurize,
thereby providing a modified liquid oat base.

2-22. (canceled)

23. The process according to claim 1, wherein step a) is performed for a period of at least 10 minutes.

24. The process according to claim 1, wherein step c) is performed for a period of at least 10 minutes.

25. The process according to claim 1, wherein step a) is performed for a period in the range 10-120 minutes.

26. The process according to claim 1, wherein step c) is performed for a period in the range 10-120 minutes.

27. The process according to claim 1, the process comprising:
a) mixing an oat material with a first liquefying endo alpha-amylase and incubate at a temperature in the range 65-80° C. at which the first liquefying alpha-amylase has amylase activity for a period of at least 10 minutes, thereby providing a first modified oat composition;
b) adjusting the temperature of the first oat composition of step a);
c) adding a second maltogenic saccharifying alpha-amylase and an endoprotease to the first modified oat composition of step b), and incubate at a temperature in the range 50-65° C., at which the second maltogenic saccharifying alpha-amylase and the endoprotease have amylase activity and endoprotease activity, respectively, for a period of at least 10 minutes, thereby providing a second modified oat composition; and
d) adjusting the temperature of the second composition of step c) to inactivate the enzymes and pasteurize;
thereby providing a modified liquid oat base.

28. The process according to claim 1, wherein the first alpha-amylase, the second alpha-amylase and the endoprotease are not produced in a genetically modified organism (GMO).

29. The process according to claim 1, wherein the modified liquid oat base exhibits an increased stability in hot acidic beverages.

30. The process according to claim 1, wherein in step a) the first liquefying alpha-amylase is BAN.

31. The process according to claim 1, wherein in step c) the maltogenic saccharifying alpha-amalyse is Fungamyl 800L.

32. The process according to claim 1, wherein in step c) the endoprotease is a metalloendoprotease.

33. The process according to claim 1, wherein
the first endo alpha-amylase is BAN 480L;
the second alpha-amylase is Fungamyl; and
the endoprotease is a metalloendoprotease.

34. The process according to claim 1,
wherein step a) is performed at a temperature in the range 65-77° C.; and/or
wherein in step b) the temperature is adjusted to a temperature in the range 45-65° C.; and/or
wherein step c) is performed at a temperature in the range 55-63° C., and/or
wherein in step d) the temperature is adjusted to at least 90° C. for at least 60seconds.

35. The process according to claim 1, wherein the modified liquid oat base
does not change the bitterness of a hot acidic beverage when it is incorporated therein.

36. The process according to claim 1,
wherein said process does not comprise the addition of exogenous beta-amylase, and/or exogenous protein-deamidase, and/or exogenous glutaminase and/or transglutaminase; and/or
wherein said process is free from genetically modified enzymes and/or enzymes produced in a genetically modified organism (GMO).

37. A modified liquid oat base comprising:
a first inactivated liquefying alpha-amylase;
a second inactivated maltogenic saccharifying alpha-amylase; and
an inactivated metalloendoprotease.

38. The modified liquid oat base according to claim 37 comprising:
inactivated BAN;
inactivated Fungamyl; and
inactivated Neutrase.

39. The modified liquid oat base according to claim 37, wherein the modified liquid oat base is incorporated in a food ingredient.

40. The modified liquid oat base according to claim 37, wherein the modified liquid oat base is incorporated in a food product.

41. A method for preparing a hot acid beverage, the method comprising introducing the modified liquid oat base according to claim 37 into the beverage.
